(19) United States
(12) Patent Application Publication
(10) Pub. No.: US 2023/0170562 A1
(43) Pub. Date: Jun. 1, 2023

(54) SEALING TOOL KIT FOR THERMAL SEALING OF A BATTERY CELL ENVELOPE AND BATTERY CELL

(71) Applicant: ROPEX Industrie-Elektronik GmbH, Bietigheim-Bissingen (DE)

(72) Inventor: Oliver Nuding, Erligheim (DE)

(21) Appl. No.: 18/071,767

(22) Filed: Nov. 30, 2022

(30) Foreign Application Priority Data
Nov. 30, 2021 (DE) 10 2021 213 570.6

(51) Int. Cl. H01M 50/183; H01M 50/105; H01M 50/178; H01M 50/124

(52) U.S. Cl. CPC H01M 50/183; H01M 50/105; H01M 50/178; H01M 50/124

(57) ABSTRACT

A sealing tool kit for thermally sealing a battery cell envelope, having a first tool which includes a base body which is shape-stable and on which a band-shaped, in particular rectangular, supporting surface is formed, wherein a length of the supporting surface is a multiple of a width of the supporting surface and wherein the supporting surface is provided with a compensating layer of a rubber-elastic material and a resistance heating tape rests on a sealing surface of the compensating layer facing away from the base body, which resistance heating tape is extended along the supporting surface and is fixed at each end to the base body, wherein a first recess and a second recess are formed on the supporting surface, each of which extends over the width of the supporting surface and is arranged at a distance from one another.

### BACKGROUND OF THE INVENTION

The invention relates to a sealing tool kit for thermally sealing a battery cell envelope, having a first tool which comprises a shape-stable/shape-fixed base body on which a band-shaped, in particular rectangular, supporting surface is formed, wherein a length of the support surface is a multiple of a width of the support surface and wherein the support surface is provided with a compensating layer of a rubber-elastic material and a resistance heating tape lies on a sealing surface of the compensating layer facing away from the base body, which resistance heating tape is extended along the support surface and is fixed at each end to the base body. Furthermore, the invention relates to a battery cell.

Sealing tool kits are known from the product range of the applicant, with which plastic film layers can be joined together in a materially bonded manner during a sealing process, whereby for this purpose a local melting of the plastic film layers to be joined together is carried out along the sealing seam provided. The thermal energy for this sealing process is provided by at least one resistance heating tape through which an electric current flows and which, due to its defined electrical resistance, enables targeted heat dissipation into the plastic film layers. In order to ensure that the thermal energy provided by the resistance heating tape is selectively coupled into the plastic film layers to be bonded together, a compressive force is applied to the plastic film layers to be bonded together in the area of the sealing seam. The resistance heating tape is supported by a rubber-like, thermally stable compensating layer, whereby the surface of this compensating layer, on which the resistance heating tape rests, can also be referred to as the sealing surface. The compensating layer, which is typically in the form of a silicone layer, is in turn applied to a supporting surface of a shape-stable base body, which base body may be made of aluminum or steel.

For example, the base body is plate-shaped or square-shaped, with the supporting surface usually being formed by a long and narrow side surface of the base body. The assembly formed by the resistance heating tape, the compensating layer and the base body can also be referred to as the first tool. Since the support surface, which is often rectangular in shape, usually has a small width dimension with respect to its length dimension, a length of the support surface being a multiple of a width of the support surface, a geometry of the support surface can also be referred to as band shaped.

The resistance heating tape is fixed to the end of the base body away from the support surface. Depending on the application, so-called clamping heads are also used for this purpose, with which the resistance heating tape can be held under a defined tension at different temperatures.

In order to be able to apply the desired compressive force to the sealing seam, a second tool must also be provided, which is arranged opposite the first tool and, together with the first tool, forms a variable-size sealing gap into which the plastic film layers to be sealed are introduced for the sealing process. For this purpose, it can be provided that at least one of the two tools (first tool and/or second tool) is/are coupled with a drive. The drive, which may be an electric or hydraulic or pneumatic linear drive) serves to adjust a distance between the first tool and the second tool and provides a force introduction between the first tool and the second tool for the execution of the sealing process.

### SUMMARY OF THE INVENTION

The object of the invention is to provide a sealing tool kit for producing an improved sealing seam and further to provide a battery cell having an improved sealing seam.

This task is solved for a sealing tool kit of the aforementioned type in that a first recess and a second recess are formed on the support surface, which are each extended over the width of the support surface and are arranged at a distance from one another. The first recess and the second recess enable additional components to be arranged and joined in the sealed seam between the two plastic film layers, a geometry of the first recess being adapted to a first cross section of a first component and a second geometry of the second recess being adapted to a cross section of the second component. These components may, for example, be plate-shaped electrodes which are provided for creating an electrically conductive connection between a pocket-shaped inner volume bounded by the plastic film layers to be sealed or welded to one another and an environment, as is the case, for example, in battery cells. By considering the cross-section of the respective component, an at least almost completely uniform surface pressure is made possible over the entire sealing seam during the execution of the sealing process, so that there are no local displacement effects due to geometric overlaps between the first tool and the two plastic film layers with the inserted components. Accordingly, the creation of a highly loadable sealing seam without weakening zones is hereby favored. Preferably, the first tool is provided for use in the manufacture of battery cells, such that the first recess corresponds to a volume of a first electrode or first component, for example a positive pole of the battery cell, while the second recess corresponds to a volume of a second electrode or second component, for example a negative pole, of the battery cell. Here, it may be provided that the first cross-section of the first component and the second cross-section of the second component are formed differently from each other. Typically, however, it is provided that the first cross-section and the second cross-section are identical.

The respective plastic film layer may be composed of one or more layers, and in the case of a multilayer structure, different plastic materials may also be used.

Advantageous further embodiments of the invention are the subject of the subclaims.

It is expedient if a first length of the first recess and/or a second length of the second recess are formed larger than the width of the supporting surface. Here it is assumed that the first length of the first recess and the second length of the second recess are each determined in the direction of a longest edge of the supporting surface or sealing surface. It is further assumed that a width of the resistance heating tape is selected to be smaller than the width of the support surface and that the components to be inserted in the sealing seam to forma a material-to-material bond with the plastic film layers have an extension in the direction of the longest edge of the support surface or sealing surface which is larger, in particular considerably larger, than the width of the support surface.

Preferably, a first base surface of the first recess and a second base surface of the second recess are each flat. This geometry of the two base surfaces takes into account the typical geometry of electrodes in battery cells, which are typically designed as plane-parallel plates, in particular made of a metallic strip material.

In a further embodiment of the invention, it is provided that the supporting surface is flat and that the first base surface and the second base surface are aligned in a common plane and/or are oriented parallel to the supporting surface. Here, it is assumed that the typically two electrodes of battery cells to be sealed/welded in between the two plastic film layers with the first tool and an associated second tool each have the same thickness and at most differ from each other in their extension in the direction of the longest edge of the support surface.

In a further embodiment of the invention, it is provided that a first layer thickness of the compensating layer, in particular of a first portion of the compensation layer, which is applied to the supporting surface is smaller than or equal to a second layer thickness of the compensating layer, in particular of a second portion of the compensation layer, which is applied to the first and the second base surfaces, respectively. In the area of the two recesses the tolerances of the components to be inserted between the two plastic film layers, for example electrodes, must also be taken into account in addition to the tolerances of the plastic film layers to be joined together. Accordingly, it is advantageous if an identical or possibly higher elasticity of the compensating layer is realized in these areas.

It is advantageous if the resistance heating tape has a length which allows the resistance heating tape to rest without tension on the supporting surface and the first and second base surfaces. This ensures that the resistance heating tape can conform to the geometry of the support surface and the recesses provided therein during the sealing process without, for example, creating a gap between the resistance heating tape and the compensating layer in concave transition areas between the support surface and the recess, which could result in an undefined cross-section for the area to be sealed. Since it must be assumed that the resistance heating tape has a minimum bending radius which is greater than zero, it can additionally be provided that transition regions between the support surface and the recess are rounded or at least beveled.

It is useful if a second tool is arranged opposite the first tool, which second tool is designed in the same way as the first tool and which forms a variable-size sealing gap with the first tool. In this way, a sealing seam can be created which is formed mirror-symmetrically with respect to a mirror plane, a surface normal of this mirror plane being aligned parallel to a distance between the first tool and the second tool.

Preferably, it is provided that a minimum distance between the sealing surfaces of the opposite arranged first and second tools corresponds to a thickness of a sealing seam for two plastic film layers of a battery cell bonded to one another, and that a minimum distance between the base surfaces of the recesses of the opposite arranged first and second tools provided with the compensating layer corresponds to a thickness of a sealing seam in which an electrically conductive electrode, in particular provided with a plastic sheathing, is accommodated between two plastic film layers.

In a further embodiment of the invention, it is provided that the base body, the compensating layer and the resistance heating tape are designed for carrying out an impulse sealing process. In an impulse sealing process, a heating of the plastic film layer area which is located adjacent to the resistance heating band is effected by a time-limited supply of current to the respective resistance heating band, followed by a cooling phase in which no further current is supplied to the respective resistance heating band.

The task of the invention is solved for a battery cell in that the battery cell has a battery cell envelope which comprises a first plastic film layer and a second plastic film layer, the first plastic film layer and the second plastic film layer being welded together in the region of a sealing seam running around the edge to form a closed pocket, and the sealing seam being penetrated by two electrodes arranged between the first plastic film layer and the second plastic film layer, which electrodes are each formed as electrically conductive strip sections, wherein a first layer thickness of the first plastic film layer and a second layer thickness of the second plastic film layer are constant along the sealing seam. Preferably, it is provided that the battery cell envelope has a rectangular geometry and that the two electrodes are arranged together at one of the four side edges of the battery cell envelope. In this case, it can be exemplarily provided that, in a first step, the two plastic film layers are joined to each other with a conventional sealing tool kit at those side edges where no electrodes are arranged. In a subsequent step, the battery plates, each of which is provided with an electrode, can then be accommodated in the pocket-like recess between the two plastic film layers and a filling process can be carried out for the pocket-like recess, for example with an electrolyte. The sealing of the fourth side edge is then carried out, whereby the sealing seam is penetrated by the two electrodes and a sealing tool kit according to the invention can be used to carry out the sealing process.

### BRIEF DESCRIPTION OF THE DRAWINGS

An advantageous embodiment of the invention is shown in the drawing. Here shows:

FIG. 1 a schematic and not to scale side view of a first tool of a sealing tool kit,

FIG. 2 a schematic and not to scale top view of the first tool of the sealing tool kit,

FIG. 3 a schematic and not to scale top view of a battery cell and

FIG. 4 a schematic and non-scale side view of the battery cell received between the first tool and a second tool during the sealing process.

### DETAILED DESCRIPTION

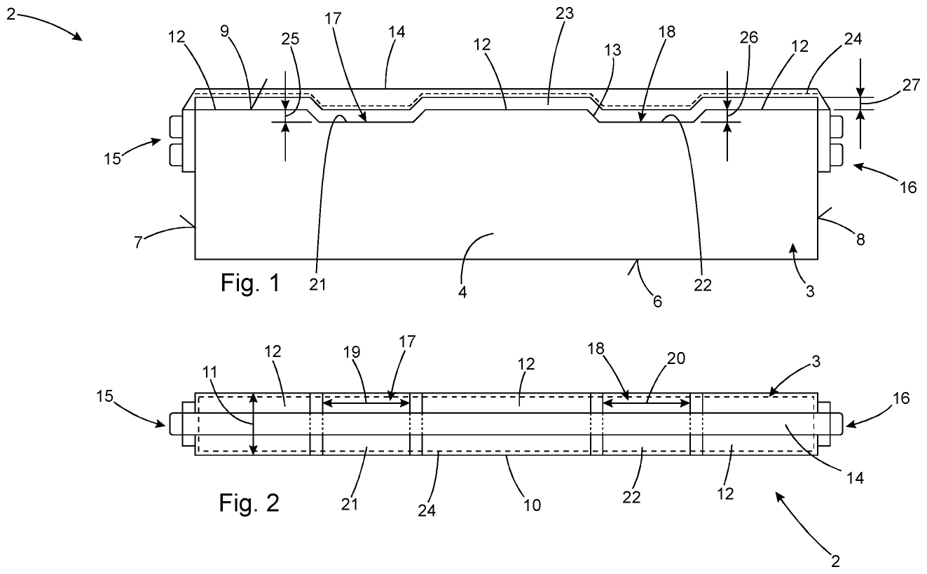

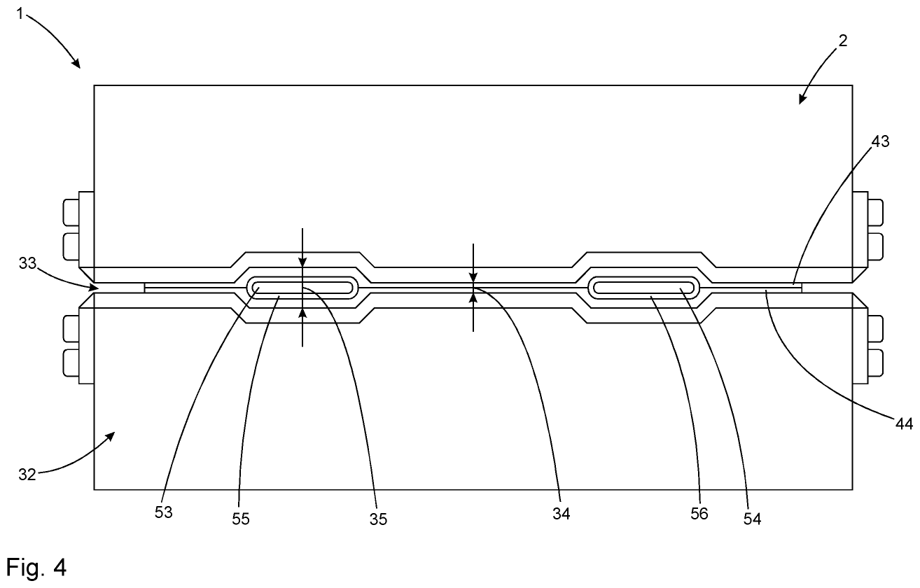

A first tool 2 of a sealing tool kit 1 shown in FIG. 4 is schematically shown in FIG. 1 and comprises a shape-stable base body 3. By way of example, the base body 3 is substantially cuboidal-shaped and comprises a flat first side surface 4 arranged in the plane of representation of FIG. 1. Adjacent to the first side surface 4, the base body 3 has a first end surface 6, a second end surface 7 and a third end surface 8, each of which is flat. Furthermore, the first side face 4 is adjoined by a fourth end face 9, which is also referred to as the support face and which, in contrast to the other end faces 6 to 8, is provided with a profile that can be seen in FIG. 1.

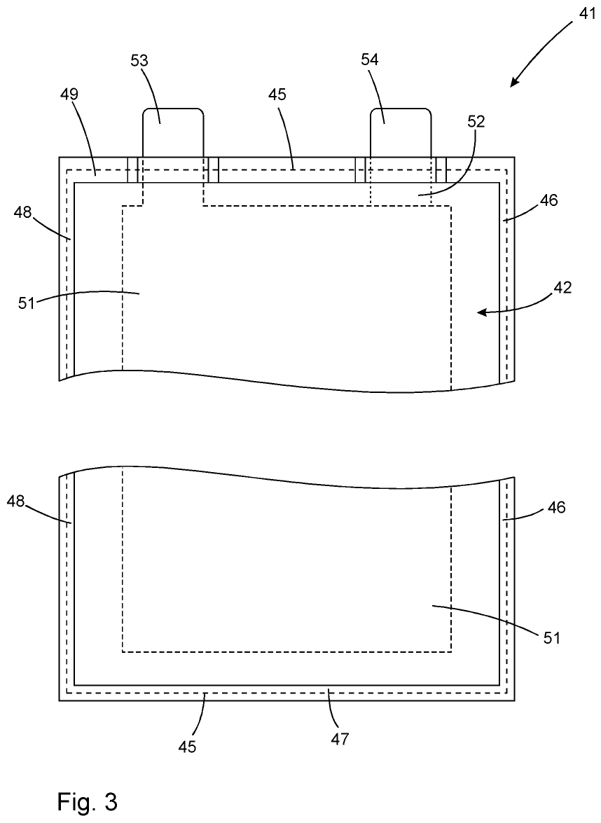

The profiling of the fourth end face 9 is determined by a first recess 17 and by a second recess 18, which are each formed in the same way and which are introduced into the base body 3 starting from a surface 12 of the fourth end face 9. Both the first recess 17 and the second recess 18 extend, as shown in FIG. 2, over an entire width 11 of the base body 3 and have a flat first base surface 21 or a flat second base surface 22.

A length 19 of the first recess 17 and a length 20 of the second recess 18 in the direction of a longest edge 10 of the base body 3 is approximately a factor of 2 greater than the width 11 of the base body 3. A first depth 25 of the first recess 17 and a second depth 26 of the second recess 18 are chosen to be the same in a purely exemplary manner, so that the base surfaces 21 and 22 are not only aligned parallel to one another, but are rather arranged in a common, unspecified plane. Exemplarily, it is provided that an inclined surface 13 also referred to as chamfer is provided between the surface 12 and the respective base surfaces 21, 22 in order to prevent excessive angling of the resistance heating tape 14 during the performance of the sealing process.

As can also be seen from FIG. 1, the resistance heating tape 14 extends from the second end face 7 to the third end face 8 and is secured at each end by a first fastening means 15 to the second end face 7 or at each end by a second fastening means 16 to the third end face 8.

A compensating layer 23 made of a rubber-elastic material, in particular a silicone material, is applied to the fourth end face 9. The task of this compensating layer 23 is to compensate for annular thickness deviations of the components to be processed together, for example the components of the battery cell 41 described in more detail below. A surface of the compensating layer 23 facing away from the base body 3 is also referred to as the sealing surface 24. Exemplarily, it is provided that a first layer thickness 27 of the compensating layer 23 in the region of the surface 12 as well as a second layer thickness 28 of the compensating layer 23 in the region of the two recesses 17, 18 are identical in each case, so that a compliance or resilience of the first tool 2 is also largely identical over its entire length 10.

As can be seen from the representation of FIG. 2, the compensating layer 23 completely covers the fourth end face 9, which is rectangular in plain view, while the resistance heating tape 14 runs centrally over the end face 9 and has a smaller width than the base body 3.

In the illustration of FIG. 3, a battery cell 41 is schematically shown which comprises a pocket-shaped battery cell envelope 42. By way of example, the battery cell envelope 42 is formed from two rectangular plastic film layers 43, 44, which are joined to one another at the edges to form a pressure tight seal and a material bond, thus forming a front side and a rear side of the battery cell envelope 42.

For this purpose, the two plastic film layers 43, 44 are joined by a circumferential sealing seam 45. This sealing seam 45 comprises, purely by way of example, a total of four sealing seam sections 46, 47, 48 and 49, each designed in a straight line. The two plastic film layers 43, 44 are initially to be joined to one another in the region of the sealing seam sections 46, 47 and 48 with conventional sealing tools, not shown, and the first and second battery plates 51, 52, provided purely by way of example, are then to be inserted into the battery cell envelope 42 through the opening which still exists in the battery cell envelope 42. Subsequently, the pocket-shaped interior of the battery cell envelope 42 can be filled with a liquid or gel electrolyte. Subsequently, the battery cell envelope 42 is sealed by a sealing process with which the fourth sealing seam 49 is produced using the sealing tool kit 1 shown in FIG. 4. In this process, a first electrode connected to the first battery plate 51 and a second electrode 54 connected to the second battery plate 52 penetrate the sealing seam 45 in the region of the fourth sealing seam section 49.

In the sealing tool kit 1 shown in FIG. 4, in addition to the first tool 2 already described, a second tool 32 is provided which is identical to the first tool 2 and is arranged as a mirror image of the first tool 2. The first tool 2 and the second tool 32 are assigned a drive device, not shown, with which a distance between the first tool 2 and the second tool 32 can be adjusted, whereby a variable-size sealing gap 33 is formed between the first tool 2 and the second tool 32.

In the illustration of FIG. 4, the position is shown which the first tool 2 assumes with respect to the second tool 32 at the time of carrying out the sealing process for the fourth sealing seam section 49. In this case, a first distance 34 between the surface 12 of the first tool 2 and the surface 12 of the second tool 32 is selected in such a way that the respective compensating layers 23 are elastically deformed and exert the desired force introduction on the first and second plastic film layers 43, 44 resting on one another.

Furthermore, a second distance 35 between the first base surface 21 of the first tool 2 and the first base surface 21 of the second tool 32 or between the second surface 22 of the first tool 2 and the second base surface 22 of the second tool 32 is dimensioned such that a composite of the two plastic film layers 43, 44, the first electrode 53 or the second electrode 54 and a first electrode sheathing 55 associated with the first electrode 53 and formed from plastic film or an electrode sheathing 56 associated with the second electrode 54 and formed from plastic film is subjected to an identical or at least similar surface pressure as is the case in the region of the opposing surfaces 12.

The first distance 34 in the sealing gap 33 is dimensioned such that it is slightly smaller than a sum of a first layer thickness of the first plastic film layer 43 and a second layer thickness of the second plastic film layer 44.

Furthermore, the second distance 35 in the sealing gap 33 is dimensioned such that it is slightly smaller than a sum of the first layer thickness of the first plastic film layer 43, the second layer thickness of the second plastic film layer 44, a thickness of the first or second electrode 53, 54, and a double thickness of the first or second electrode sheath 55, 56.

Furthermore, a length of the resistance heating tape 14, which according to FIG. 1 rests only loosely on the fourth end face 9, is dimensioned in such a way that the resistance heating tape 14 rests at least almost stress-free on the profiling formed by the surfaces 12 and the recesses 17, 18 and thus the desired uniform surface pressure is ensured over the entire length of the fourth sealing seam section 49.

What is claimed is:

1. A sealing tool kit for thermally sealing a battery cell envelope, having a first tool which comprises a shape-stable base body on which a band-shaped supporting surface is formed, wherein a length of the supporting surface is a multiple of a width of the supporting surface and wherein the supporting surface is provided with a compensating layer of a rubber-elastic material and wherein a resistance heating strip rests on a sealing surface of the compensating layer, which sealing surface faces away from the base body, which heating strip is extended along the supporting surface and is fixed at each end to the base body, wherein a first recess and a second recess are formed on the supporting surface, wherein the first recess and the second recess extend over the width of the supporting surface and wherein the first recess and the second recess are arranged at a distance from one another.

2. The sealing tool kit according to claim 1, wherein a first length of the first recess is greater than the width of the supporting surface and/or wherein a second length of the second recess is greater than the width of the supporting surface.

3. The sealing tool kit according to claim 1, wherein a first base surface of the first recess is flat and wherein a second base surface of the second recess is flat.

4. The sealing tool kit according to claim 3, wherein the supporting surface is flat and wherein the first base surface and the second base surface are aligned in a common plane and/or wherein the first base surface and the second base surface are oriented parallel to the supporting surface.

5. The sealing tool kit according to claim 3, wherein a first layer thickness of the compensating layer, which is applied to the supporting surface, is smaller than or equal to a second layer thickness of the compensating layer which is applied to the first and the second base surface.

6. The sealing tool kit according claim 1, wherein a length of the resistance heating tape is chosen to ensure that the resistance heating tape is to be placed without tension on the supporting surface and the first and second base surfaces.

7. The sealing tool kit according to claim 3, wherein a second tool is arranged opposite the first tool, which second tool is identical with the first tool and which second tool delimits a variable-size sealing gap with the first tool.

8. The sealing tool kit according to claim 7, wherein a minimum distance between the sealing surfaces of the first tool and a sealing surface of the second tool corresponds to a thickness of a sealing seam for two interconnected plastic film layers of a battery cell, and wherein a minimum distance between the base surfaces of the first and second recesses of the opposite arranged first and second tools corresponds to a thickness of a sealing seam in which an electrically conductive electrode is accommodated between two plastic film layers.

9. The sealing tool kit according to claim 1, wherein the base body, the compensating layer and the resistance heating tape are designed for carrying out an impulse sealing process.

10. A battery cell having a battery cell envelope with a first plastic film layer and with a second plastic film layer, the first plastic film layer and the second plastic film layer being welded to form a closed pocket in the region of a sealing seam running around an edge of the battery cell envelope and the sealing seam being penetrated by two electrodes arranged between the first plastic film layer and the second plastic film layer, which electrodes are each formed as electrically conductive strip sections, wherein a first layer thickness of the first plastic film layer and a second layer thickness of the second plastic film layer are constant along the sealing seam.
